(19) United States
(12) Patent Application Publication
(10) Pub. No.: US 2008/0092612 A1
(43) Pub. Date: Apr. 24, 2008

(54) Method of Processing and Using Paint Sludge

(75) Inventor: Toshihisa Miyazaki, Akiruno-shi Tokyo (JP)

Correspondence Address: LOWE HAUPTMAN HAM & BERNER, LLP, 1700 DIAGONAL ROAD, SUITE 300, ALEXANDRIA, VA, 22314, US

(73) Assignee: AGRICULTURAL RECYCLING SYSTEM GOUSIGAISYA, Tokyo (JP)

(21) Appl. No.: 11/568,928

(22) PCT Filed: May 11, 2004
(86) PCT No.: PCT/JP04/06261

§ 371 Date: Nov. 10, 2006

(51) Int. Cl. C05F 7/00; B09B 3/00

(52) U.S. Cl. 71/25; 435/262.5

(57) ABSTRACT

The object of the present invention is to economically process muddy paint sludge that is generated in painting, without destroying the natural environment, and to effectively utilize the processed product. The present invention's method of processing paint sludge comprises: (1) a first process, by which a first compost-like product is produced by fermenting organic waste under an aerobic condition and under the condition that the organic waste has a moisture content of 50%-60%, (2) a second process, by which the first compost-like product is mixed with paint sludge in such a way that the moisture content of the mixture becomes 50%-60% and the temperature of the mixture becomes about 60° C., and (3) a third process, by which the paint sludge in the mixture is processed into fine grains by fermenting heat generated by aerobic microbes in the first compost-like product.

### FIELD OF THE INVENTION

The present invention relates to a technique to process paint sludge without using an artificial heat source, and to a recycling technique to reuse processed paint sludge.

### BACKGROUND OF THE INVENTION

Paint sludge is paint mist that is produced in a painting facility, being collected in the form of mud or clay after the painting equipment and painted products are washed with water after painting is completed. Paint sludge contains, as its ingredients, inorganic or organic pigments, synthetic resins, and organic solvents. To dispose of paint sludge, typically it is incinerated, and then the incinerated ashes are buried. As one method of processing paint sludge, Japanese Unexamined Published Patent Application No. H10-204457 discloses a method of converting the paint sludge into solid fuel by mixing it with waste and subjecting the mixture to pressure, after which the pressed paint-sludge mixture is subjected to heat setting (i.e., solidified by being heated). This method comprises the following processes:

(1) Paint sludge, whose primary ingredient is a thermosetting resin, is put in a vertical mixer together with waste;

(2) The paint sludge and the waste are mixed together and pressed, and the resulting pressed paint-sludge mixture is then pushed out of the mixer by rotor blades inside the mixer;

(3) The pressed paint-sludge mixture and waste, which are pushed out of the mixer in the form of a molded product having a large mass or a pellet-like shape, drop onto a conveyor belt that transports them to a furnace; and

(4) The pressed paint-sludge mixture is hardened by being heated by a far-infrared heater in the furnace, so that this mixture is converted into solid fuel, which is later removed.

Japanese Unexamined Published Patent Application No. 2002-192197 discloses another method of processing and recycling paint sludge. This method comprises the following processes:

(1) A first drying process, wherein (a) the paint sludge is crushed by a crusher, and (b) the crushed paint sludge is stirred and dried by a stirring dryer while being heated in an atmospheric environment, so that the paint sludge will have a predetermined moisture content, and

(2) A second drying process, whereby the dried paint sludge from the first drying process is stirred - at a higher speed than in the first drying process—and dried by a stirring dryer, while being heated in a vacuum, so that the paint sludge will have a predetermined moisture content.

(Patent Document 1) Japanese Unexamined Published Patent Application No. 10-204457

(Patent Document 2) Japanese Unexamined Published Patent Application No. 2002-192197

### DISCLOSURE OF THE INVENTION

### Problems To Be Solved

The problems of the incineration methods described in the preceding “Background of the Invention” section are (1) a large amount of carbon dioxide is generated, and (2) a repository site at which to bury ashes is needed, both of which result in a heavy burden on the environment. Also, making solid fuel by heat setting (i.e., solidifying by heating”) or drying by heating in a vacuum is very costly, which is another problem.

One objective of the present invention is to economically process paint sludge without using an artificial heat source, thereby reducing the amount of carbon dioxide that is generated by combustion, and thereby preventing damage to the natural environment. Another objective is to provide a product (1) that is obtained by processing paint sludge, (2) that is biodegradable and that improves the soil, and (3) that can be used as a raw material for producing other products.

### Means of Solving the Problems

The present invention's method of processing paint sludge comprises the following three processes:

(1) A first process, by which a first compost-like product is produced by fermenting organic waste under an aerobic condition and under the condition that said organic waste has a moisture content of 50%-60%;

(2) A second process, by which the first compost-like product is mixed with paint sludge in such a way that the moisture content of the mixture becomes 50%-60% and that the temperature of the mixture becomes about 60° C.; and

(3) A third process, by which the paint sludge in the mixture is processed into fine grains by fermenting heat generated by aerobic microbes in the first compost-like product.

In addition, in the present invention's method of processing paint sludge,

(1) The organic waste that remains after the third process described above is used as a second compost-like product; and

(2) The second compost-like product is mixed with paint sludge to carry out the second process described above, and then (3) the third process described above is carried out.

In the present invention's method of using paint sludge, the products obtained by Claim 1 or 2, set forth below, are biodegradable and improve the soil.

### Effects of the Invention

Paint sludge produced in a painting facility is in the form of mud or clay, and is therefore difficult to handle. In the present invention, paint sludge is changed into fine grains by fermenting heat from aerobic microbes, so that the paint sludge can be handled easily and then recycled. Due to the application of such fermenting heat generated by aerobic microbes, an artificial heat source for incinerating or heating is not necessary. As a result, the amount of carbon dioxide as an exhaust product can be reduced, whereby the natural environment can be protected, and paint sludge can be processed economically.

In the first process,

(1) An environment that is suitable for reproduction of aerobic microbes is provided;

(2) A compost-like product that activates the aerobic microbes is produced from organic waste; and, in particular,

(3) A first compost-like product -which can be used in processing paint sludge -can be produced by fermenting the organic waste under the condition that the organic waste has a moisture content of 50%-60%, as well as under an aerobic condition.

After the first compost-like product has been used to process the paint sludge, the first compost-like product can repeatedly be used as a second compost-like product.

The paint sludge, which has been changed into fine grains, is easy to handle and can be used as a raw material for producing a variety of biodegradable and soil-improvement products.

### PREFERRED EMBODIMENT OF THE INVENTION

In this embodiment of the present invention, a compost-like product—which is produced by using aerobic microbes to ferment organic waste—is mixed with muddy paint sludge, and the paint sludge is changed into fine grains in about two weeks by using fermenting heat from the group of aerobic microbes contained in the compost-like product (i.e., the third process). In order that the paint sludge is changed into fine grains, there is an earlier pre-processing stage (i.e., the second process) in which the compost-like product is mixed with the paint sludge to obtain a mixture under a temperature suitable for activating the aerobic microbes. To process a large quantity of paint sludge, highly fermentative and activated aerobic microbes need to be secured by culturing such microbes constantly and in large quantities. For this purpose, a first fermenter (for instance, the garbage disposal described in U.S. Pat. No. 3,154,473) that has a high-speed vertical-rotation function is useful. Then, fermentation is successively carried out as appropriate by using a second fermenter (i.e., a kiln-type or spiral-type horizontal fermenter), or by using an accumulation method in which mixtures are accumulated together.

### EXAMPLE

Before using the present invention, a large quantity of compost-like product was produced so that aerobic microbes would reproduce themselves in the compost-like product (the first process). In order to produce a large quantity of compost-like product, (1) (a) a fermentation accelerator into which fermentative microbes had been seeded, and (b) organic waste, such as garbage, sludge from a septic tank, and livestock excreta, are first put into a fermentation machine (hereinafter “fermenter”) that has a high-speed vertical-rotation function, (2) chaff and the like are added to said fermentation accelerator and organic waste, so that the moisture content of the whole mixture will be 50%-60%, and (3) those materials are then stirred for about one hour, by which time the temperature in the fermenter has risen to 60° C. Then the next day, the compost-like product is taken out of said fermenter, then put into a horizontal fermenter and stirred uniformly for 10 minutes per day (for 12 days) while oxygen is supplied thereto. Thereafter, the horizontal fermenter is stopped so that aerobic microbes can be cultivated in the compost-like product (fermentation temperature: about 60° C.-70° C.; moisture content: 35%) that was thus produced and in which normal-temperature bacteria and thermophilic bacteria had proliferated to a bacterial count of 8.16×10⁸ CFU/g-ds and 3.02×10⁸ CFU/g-ds, respectively, in the compost-like product.

In this example of the present invention, an experiment was conducted to confirm that, by mixing said compost-like product with muddy paint sludge, the paint sludge changes its form into fine grains due to the fermenting heat generated by the aerobic microbes, and to find out to what extent the weight of the paint sludge can be reduced, and how many days the process requires.

In this experiment, 100 kg of a compost-like product (moisture content: 35%) and 100 kg of muddy paint sludge (moisture content: 70%) were put into a fermenter having a high-speed vertical-rotation function and were then stirred for 30 minutes (temperature in the fermenter: 60° C.), so that a mixture having a moisture content of 52.5%, which is suitable for fermentation using aerobic microbes, was obtained (the second process). Next, a plurality of mixtures that had been obtained in the above-mentioned way were accumulated, the entire combined mixture was stirred uniformly with a shovel once each day (24 hours) so as to supply oxygen thereto, and changes in the fermentation temperature were recorded for 17 days. Stirring with a shovel is almost the same process as stirring with a kiln-type or spiral-type horizontal fermenting machine (a) once a day. Below are Table 1, which shows changes in the fermentation temperature over the 17-day period, and Table 2, which is a graph showing the same data.

TABLE 1

| | Day | | | | | | | | | | | | | | | | |
|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | 17 |
| Temperature | 33 | 55 | 58 | 55 | 56 | 57 | 60 | 64 | 59 | 57 | 57 | 47 | 45 | 34 | 33 | 33 | 30 |

As shown by Table 1 and Table 2, the mixture, which was produced in the pre-processing stage (the second process), started fermentation at a high temperature of 55° C. on the next day of the pre-processing, and this high fermentation temperature continued for 10 days thereafter. Due to the continuation of such a high fermentation temperature, muddy paint sludge gradually changes its form into a fine-grained material (the third process) and decreases in weight.

This high temperature is maintained by fermenting heat generated by the aerobic microbes—not by an artificial heat source—which is economical. More specifically, to supply oxygen it is only necessary to take the mixture out of the fermenter after the pre-processing stage and to stir the entire mixture uniformly with a shovel for 10 minutes once a day over a period of 17 days; this serves to protect the natural environment. Further, even if a stirrer is used in the fermentation process to stir the entire mixture for about 10 minutes once a day, that costs far less than in the case of the conventional method of processing paint sludge by incineration.

How the paint sludge changes when it is processed will now be described.

First, in the pre-processing stage, in which the compost-like product and muddy paint sludge are put in the fermenting machine to be stirred for about 30 minutes, the following happens. Immediately after the start of stirring, the temperature in the fermenter rises, and because of this, the solvent contained in the paint sludge evaporates, which generates an unpleasant odor. When the 30-minute stirring process is completed, however, the odor rapidly abates. The muddy paint sludge, which was in the form of a big mass before processing, is changed into fine grains. Although some of the grains are medium-sized and not very small (having a diameter of about 5 cm), the material is certainly easier to handle than it was as muddy paint sludge before processing. Further, as days pass, the medium-sized grains having a diameter of 5 cm also change into fine grains, and the material becomes even easier to handle.

An experiment was conducted to evaluate changes in the weight of paint sludge over a 25-day period. Table 3 below shows the result of the experiment (days and temperature), and Table 4 below is a graph that shows changes in the weight of the paint sludge due to fermenting heat. In this example of the present invention, the mixture was made by putting 100 kg of compost-like product and 100 kg of muddy paint sludge in a fermenter to be stirred. Thus, the weight of the mixture on the first day of the experiment was 200 kg. Measurement was done every seven days, and the final measurement was done on the 25th day.

TABLE 3

Days

| | 1 | 7 | 14 | 25 |
|---|---|---|---|---|
| Temperature | 200 | 178 | 134 | 120 |

As shown in Table 3 and Table 4 above, the weight of the mixture, which was produced in the per-processing stage, had decreased by 22 kg by the 7th day, by 66 kg by the 14th day, and by 80 kg by the 25th day, resulting in a 40% weight reduction over the entire processing period of 25 days. Incidentally, the 25th day is the day when processing of the paint sludge was completed, and the processed paint sludge came to have properties making it suitable for use as a raw material for a variety of products.

There is irregularity in the sizes of the grains of the processed paint sludge. However, to make the processed paint sludge useful as material for various products, the size of the grains needs to be uniform. More specifically, usage of the paint sludge differs depending on the size of its grains. Therefore, the processed paint sludge should be sorted into three groups (i.e., fine grains, small grains, and medium-size grains) using a sifter. Fine or small grains are suitable as material for a roadbed and for cushioning, whereas medium-size grains are suitable as for use as solid fuel. In addition, after sifting the paint sludge, residues are obtained. These residues can be used as a compost-like product to be mixed with other muddy paint sludge while supplying organic waste to the mixture. Thus, the operation of turning paint sludge into fine grains can be done repeatedly.

The product that contains grains of paint sludge is biodegradable. For instance, in the case of using this product for manufacturing a pot for a seedling (e.g., a pot for a nursery tree), a pot that decomposes underground can be provided. In the case of a conventional vinyl pot in which a seedling is planted, it is necessary to take the seedling out of the pot (in other words, separate the pot from the seedling) before planting the seedling in a field. However, with these biodegradable pots, it is not necessary to take a seedling out of its pot before planting the seedling in a field; the seedling can be planted together with its pot, thus improving working efficiency. Incidentally, this pot for seedling is produced as a mixture of paint sludge (40%) and waste paper (60%). This pot starts to lose its shape in one month after being planted in a field, and it decomposes within four months after being planted. Moreover, recycling of paint sludge by processing it into grains can prevent the production of dioxins, which cannot be avoided in the case of a conventional method of disposing of paint sludge by incinerating it. Thus, the recycling method of the present invention can reduce the burden on the environment.

Similarly, a multi-purpose sheet, which can be used as a material for restraining the growth of weeds (by covering the ground so as to block sunlight and rainwater from entering the ground, which normally help weeds to grow) or as a material for keeping warm, was produced using a product containing grains of paint sludge. This multi-purpose sheet is manufactured via the following process: Paint sludge (50%) and waste paper (50%)—namely, old newspapers —are mixed together, pulverized, and then processed by hand (the same method as that used in producing hand-made Japanese paper). Thus, this multi-purpose sheet comes to have the same biodegradability as the above-described seedling pot. Therefore, this multi-purpose sheet can reduce the cost for disposing of it, whereas to dispose of a conventional vinyl multi-purpose sheet entails some cost. Thus, this multi-purpose sheet of the present invention helps to reduce the burden on the environment.

Further, pellet-like products were produced using a mixture containing grains of paint sludge. These pellet-like products are usable as a raw material for organic fertilizers (i.e., as a soil improver) and for fuel pellets. Incidentally, according to Japan's Fertilizer Control Law, muddy paint sludge is categorized as a mud-fermentation fertilizer. To be exact, muddy paint sludge is categorized as a soil improver. Specifically, a test of the growth of komatsuna (Japanese mustard spinach) was carried out using this soil improver. A germination test and a growth test both showed good results. Also, no toxic substance was detected when a toxic-substance detecting test in accordance with Fertilizer Control Law was performed before carrying out this growth test.

1. A method of processing paint sludge, with said method comprising:
a first process, by which a first compost-like product is produced by fermenting organic waste under an aerobic condition and a condition such that the organic waste has a moisture content of 50%-60%;
a second process, by which the compost-like product of the first process is mixed with paint sludge in such a way that the moisture content of the mixture becomes 50%-60% and the temperature of the mixture becomes about 60° C.; and
a third process, by which the paint sludge in the mixture is processed into fine grains by fermenting heat that is generated by aerobic microbes in the first compost-like product.

2. The method of processing paint sludge as set forth in claim 1, wherein
the organic waste that remains after said third process is used as a second compost-like product,
the second compost-like product is mixed with paint sludge to carry out said second process; and then
the third process is carried out.

3. The method of applying paint sludge, wherein the product obtained by claim 1 is biodegradable.

4. The method of applying paint sludge, wherein the product obtained by claim 1 has soil-improvement capabilities.

5. The method of applying paint sludge, wherein the product obtained by claim 2 is biodegradable.

6. The method of applying paint sludge, wherein the product obtained by claim 2 has soil-improvement capabilities.
